(19) United States
(12) Patent Application Publication
(10) Pub. No.: US 2018/0241670 A1
(43) Pub. Date: Aug. 23, 2018

(54) SOFTWARE SWITCH FOR PROVIDING NETWORK FUNCTION AND OPERATION METHOD THEREOF

(71) Applicant: KOREA ADVANCED INSTITUTE OF SCIENCE AND TECHNOLOGY, Daejeon (KR)

(72) Inventors: Seungwon Shin, Daejeon (KR); Taejune Park, Daejeon (KR); Yeonkeun Kim, Daejeon (KR)

(21) Appl. No.: 15/886,076

(22) Filed: Feb. 1, 2018

(30) Foreign Application Priority Data
Feb. 22, 2017 (KR) 10-2017-0023545

(51) Int. Cl. H04L 12/741; H04L 29/06; G06F 17/30

(52) U.S. Cl. CPC H04L 45/74; G06F 17/30707; H04L 69/22

(57) ABSTRACT

A software switch for providing a network function and an operation method thereof are provided. The software switch includes an extraction unit configured to, when a packet is received, extract packet header information from the received packet, a search unit configured to search for an identical flow rule among pre-determined flow rules based on the extracted packet header information, a performance unit configured to, when the identical flow rule is found, execute actions in which a network function for the found flow rule is previously defined, and a transmission unit configured to transmit a packet in which the actions are executed to a destination.

### CROSS-REFERENCE TO RELATED APPLICATIONS

A claim for priority under 35 U.S.C. § 119 is made to Korean Patent Application No. 10-2017-0023545 filed Feb. 22, 2017, in the Korean Intellectual Property Office, the entire contents of which are hereby incorporated by reference.

### BACKGROUND

Embodiments of the inventive concept described herein relate to a software switch for providing a network function, and more particularly, relate to a software switch for directly providing a network function in a process of forwarding traffic at a network switch and an operation method thereof.

To provide an additional function to a network in a data center/cloud environment, separate equipment, for example, a firewall, an intrusion detection system/intrusion prevention system (IDS/IPX), a proxy, or the like should be located.

However, conventional equipment may have cost problems and shortcomings in which it is difficult to cope actively with a rapidly changed network environment.

To address such problems, as shown in FIG. 1, network function virtualization (NFV) technology for providing respective network functions in the form of equipment virtualized in software to overcome cost problems and coping actively with changes in network situation has been developed.

However, there may be the following shortcomings in the NFV technology.

First, duplicated traffic may be generated to bypass network traffic to an NFV host, and a delay time to an original destination may occur.

Finally, there is a need of complex traffic steering to transmit network traffic to the NFV host. Thus, a forwarding table of each network switch is complicated, and misconfiguration of a network occurs frequently.

To address the above-mentioned shortcomings and problems, an inventive concept provides a software switch for providing a network function.

### SUMMARY

Embodiments of the inventive concept provide a software switch for providing a network function and an operation method thereof.

Embodiments of the inventive concept provide a software switch for providing an action clustering function capable of easily and simply applying the same network function policy to several network flows.

Embodiments of the inventive concept provide a software switch for immediately processing traffic without the necessity of bypassing the traffic by immediately providing a network function at each network switch to provide the network function to a process of being processed on a traffic path.

According to an aspect of an embodiment, a software switch may include an extraction unit configured to, when a packet is received, extract packet header information from the received packet, a search unit configured to search for an identical flow rule among pre-determined flow rules based on the extracted packet header information, a performance unit configured to, when the identical flow rule is found, execute actions in which a network function for the found flow rule is previously defined, and a transmission unit configured to transmit a packet in which the actions are executed to a destination.

The software switch may further include a database (DB) configured to store the flow rules and actions defined for each of the flow rules. The search unit may be configured to search the DB for the identical flow rule.

Each of the actions stored in the DB may be assigned a pre-defined cluster identification (ID) value. The same policies may be shared when different flow rules have the same cluster ID by providing an action clustering function of configuring actions having the same cluster ID as the same cluster.

The software switch may include a software switch based on a software defined network (SDN)/OpenFlow.

According to another aspect of an embodiment, an operation method of a software switch may include, when a packet is received, extracting packet header information from the received packet, searching for an identical flow rule among pre-determined flow rules based on the extracted packet header information, when the identical flow rule is found, executing actions in which a network function for the found flow rule is previously defined, and transmitting a packet in which the actions are executed to a destination.

The searching may include searching a DB configured to store the flow rules and actions defined for each of the flow rules for the identical flow rule.

Each of the actions stored in the DB may be assigned a pre-defined cluster ID value. The executing may include sharing the same policies when different flow rules have the same cluster ID by providing an action clustering function of configuring actions having the same cluster ID as the same cluster.

The method may include performing an operation in a software switch based on an SDN/OpenFlow.

### BRIEF DESCRIPTION OF THE FIGURES

The above and other objects and features will become apparent from the following description with reference to the following figures, wherein like reference numerals refer to like parts throughout the various figures unless otherwise specified, and wherein:

FIG. 1 is a drawing illustrating a network function virtualization (NFV)-based network;

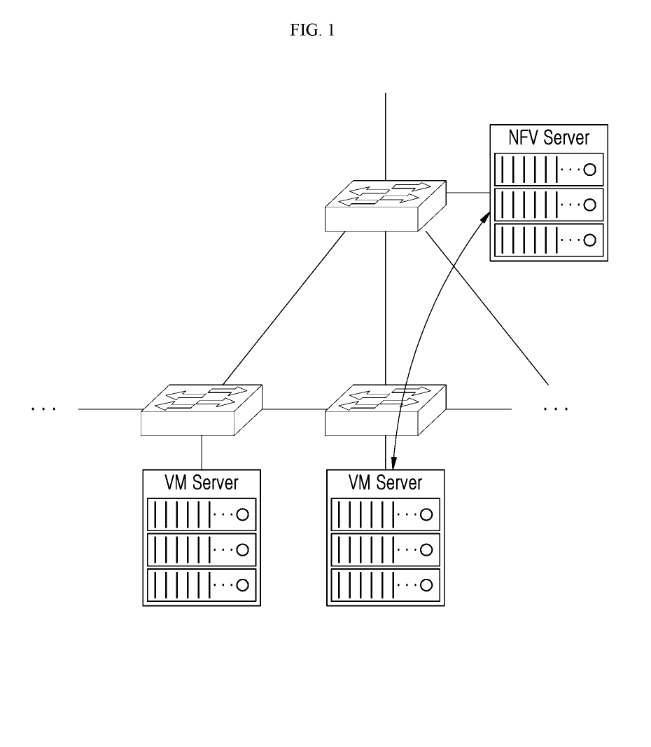

FIG. 2 is a drawing illustrating a configuration of a system for describing a software switch according to an embodiment of the inventive concept;

FIG. 3 is a flowchart illustrating an operation method of a software switch according to an embodiment of the inventive concept;

FIG. 4 is a drawing illustrating a software switch for providing a network function according to an embodiment of the inventive concept;

FIG. 5 is a drawing illustrating an internal structure of a software switch according to an embodiment of the inventive concept;

FIG. 6 is a drawing illustrating a software switch for providing a network function to which an action clustering function is applied, according to an embodiment of the inventive concept;

FIG. 7 is a drawing illustrating a structure of action clustering; and

FIG. 8 is a block diagram illustrating a configuration of a software switch according to an embodiment of the inventive concept.

### DETAILED DESCRIPTION

Hereinafter, a description will be given in detail of embodiments with reference to the accompanying drawings. However, the present disclosure is restricted or limited to embodiments of the present disclosure. Further, like reference numerals shown in each drawing indicates like members.

Embodiments of the inventive concept may provide the gist of providing a software switch for providing an action clustering function capable of easily and simply applying the same network function policy to several network flows.

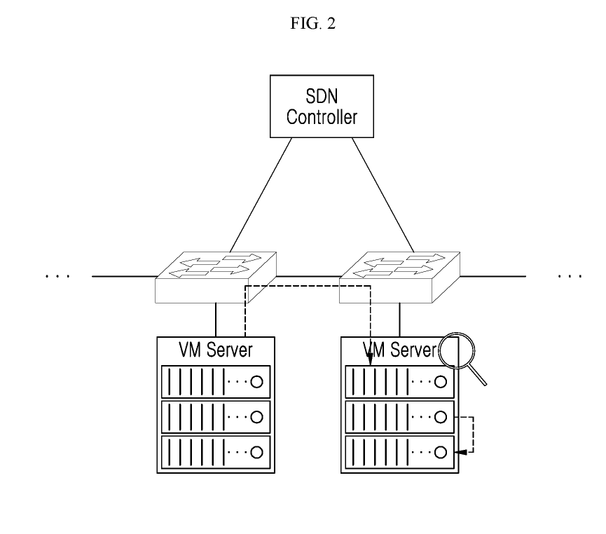

FIG. 2 is a drawing illustrating a configuration of a system for describing a software switch according to an embodiment of the inventive concept. As shown in FIG. 2, the software switch may reduce a waste of a bandwidth and a delay time and may simplify a flow rule by directly providing a network function in a process where a network switch forwards traffic.

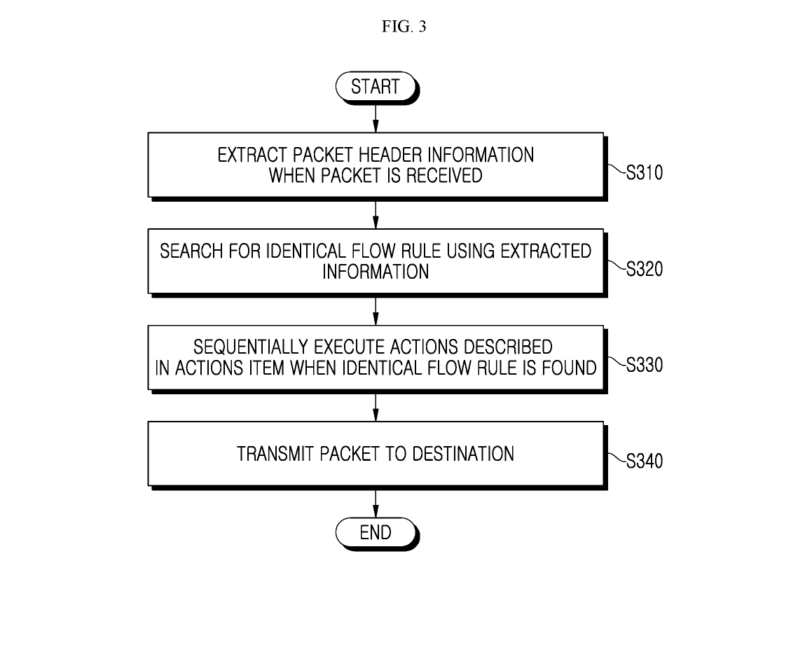

A description will be given of the software switch for providing such a network function with reference to FIGS. 3 to 8.

FIG. 3 is a flowchart illustrating an operation method of a software switch according to an embodiment of the inventive concept.

Referring to FIG. 3, in the operation method of the software switch, when a packet is received in the software switch, in operation S310, the software switch may extract packet header information from the received packet. In operation S320, the software switch may search for an identical flow rule among pre-defined flow rules using the extracted packet header information.

Herein, operation S320 may be an operation of searching a database (DB), in which a flow rule of network actions and actions associated with the flow rule are previously stored (or set), for the identical flow rule.

When the identical flow rule is found in operation S320, in operation S330, the software switch may sequentially execute actions described in an actions item of the flow rule. In operation S340, the software switch may transmit a packet in which the actions are executed to a destination.

In addition, in the operation method of the software switch according to an embodiment of the inventive concept, the software switch may provide an action clustering function of assigning a cluster ID value to network function actions stored in the DB and configuring actions having the same ID as the same cluster to determine the actions having the same ID as the same cluster. Different flow rules may share the same policies with respect to the same cluster.

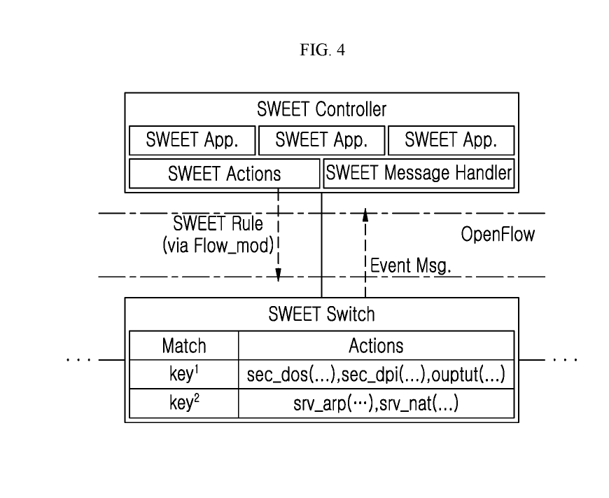

A description will be given in detail of such an embodiment of the inventive concept with reference to FIGS. 4 to 7.

FIG. 4 is a drawing illustrating a software switch for providing a network function according to an embodiment of the inventive concept. As shown in FIG. 4, the software switch according to an embodiment of the inventive concept may be a software switch based on software defined networks (SDN)/OpenFlow and may provide a network function in the form of an action.

In this case, respective network functions may be described in an actions item among items of the software switch. Functions described for an identical network flow may be provided on a match item.

For example, a network flow identical to “key¹” in the match item shown in FIG. 4 may use a denial of service (DoS) detector and a deep packet inspection (DPI) function and may be transmitted to an original destination. A network flow identical to “key2” in the match item may use an address resolution protocol (ARP) responder and a network address translation (NAT) service and may be transmitted to an original destination.

When any event occurs in respective network function actions, for example, when an event where a DoS detector detects a DoS attack occurs, such a software switch may process traffic in one of the following three forms.

First, the software switch may transmit a corresponding event to an SDN controller such that the SDN controller may control a corresponding packet. Herein, the SDN controller may have a handler capable of receiving a corresponding event message. The handler may transmit the event to respective applications such that traffic may be processed.

Second, the software switch may drop a packet such that corresponding traffic is not transmitted.

Finally, the software switch may transmit a corresponding event to another port rather than an original destination through “redirect”.

Respective network function actions provided from the software switch may be installed in the same manner as general OpenFlow actions, for example, “output”, “drop”, “flood”, and “set_nw_src”, through a flow_mod command. Only describing several network functions in order may simply configure a service chain.

The SDN controller (e.g., a SWEET controller) and the software switch according to an embodiment of the inventive concept may transmit and receive an event message and a flow rule over an OpenFlow channel. In other words, if an event occurs, the software switch may provide an event message for the occurred event to the SDN controller over the OpenFlow channel. The SDN controller may provide a flow rule for the event message to the software switch over the OpenFlow channel.

Of course, network service actions may be managed by the SDN controller.

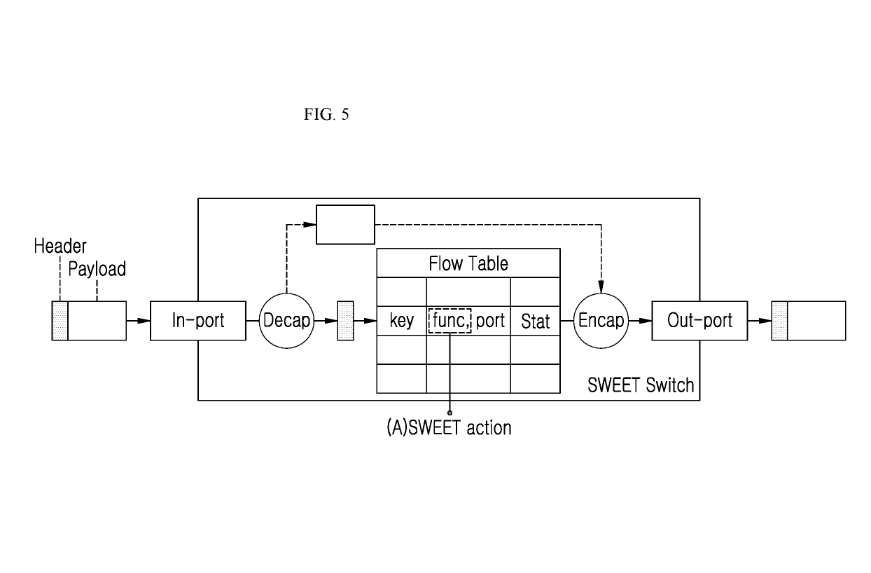

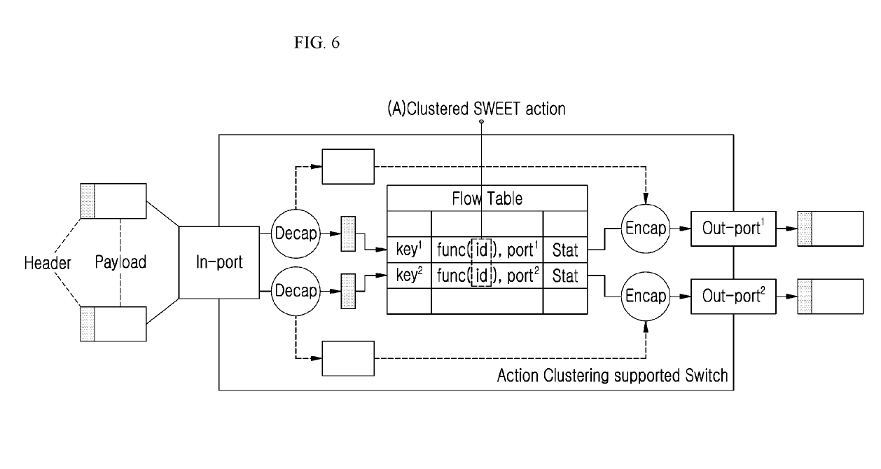

FIG. 5 is a drawing illustrating an internal structure of a software switch according to an embodiment of the inventive concept. FIG. 6 is a drawing illustrating a software switch for providing a network function to which an action clustering function is applied, according to an embodiment of the inventive concept.

As shown in FIG. 5, when a packet is input to an in-port, the software switch may extract packet header information from the input packet through a decapsulation process and may search for an identical flow rule using the extracted information, thus sequentially executing actions described in an actions item of the identical flow rule when the identical flow rule is found.

In this case, when meeting a network function action while executing an action, the software switch may perform a corresponding function.

When a packet is transmitted to a destination, the software switch may perform an encapsulation process of the packet and may transmit the encapsulated packet to the destination.

The software switch according to an embodiment of the inventive concept may have a structure of setting a policy for each network flow, but may have a structure of failing to set a policy throughout several flow rules. For example, although a DoS detection action of 100 Mbps is added to each of two flows to detect DoS of 1000 Mbps with respect to the two flows, since each of the two flows is not greater than 100 Mbps when each of the two flows enters at a speed of 99 Mbps, a DoS action may fail to detect the DoS.

There may be a need for a separate technique of using an additional flow rule, a flow table, or the like to address this. There may be a probability that such methods will make flow rules complicated to have high misconfiguration.

Thus, another embodiment of the inventive concept may provide a function of action clustering to address such a problem. As shown in FIG. 6, the action clustering in an embodiment of the inventive concept may refer to assigning a cluster ID value to respective network function actions, regarding actions having the same cluster ID as configuring the same cluster, and sharing the same policies for different flow rules.

For example, as described above, when a DoS detection action of 100 Mbps is added to each of two flows to detect DoS of 100 Mbps with respect to the two flows, the software switch may detect a time when speeds of the two flows are added to be greater than 100 Mbps since a DoS detection action of two flow rules uses the same cluster ID.

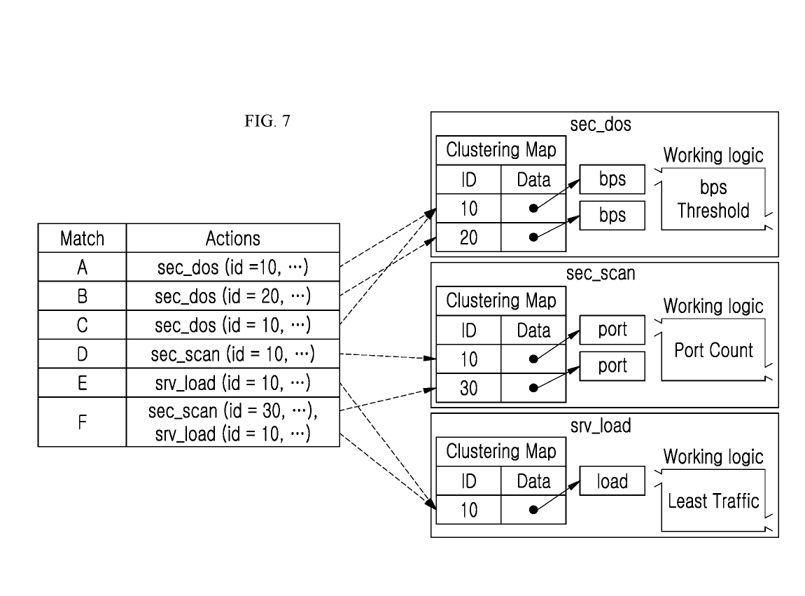

FIG. 7 is a drawing illustrating a structure of action clustering. As shown in FIG. 7, policies of network actions may be stored/managed through a hash table and a cluster ID may indicate a key of the stored policies. Thus, in a software switch according to another embodiment of the inventive concept, since different flow rules indicate the same hash value, they may share the same policy.

Of course, the software switch according to an embodiment of the inventive concept is not limited to storing/managing only one hash table for providing a network function. The software switch may store/manage a plurality of hash tables and may handle multiple flows through a connection relationship between the plurality of hash tables.

As described above, in the software switch and the operation method associated with the software switch according to an embodiment of the inventive concept, as each network switch immediately provides a network function to provide the network function in a process of being processed on a traffic path, the software switch may immediately process traffic without the necessity of bypassing the traffic.

Further, technology according to an embodiment of the inventive concept may share the same policies with respect to the same cluster ID although actions having the same cluster ID have different flow rules by providing an action clustering function capable of easily and simply applying the same network function policy to several network flows.

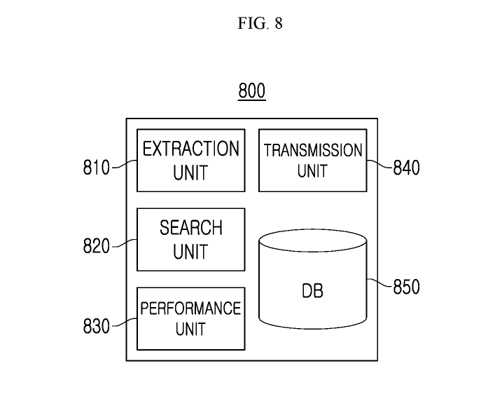

FIG. 8 is a block diagram illustrating a configuration of a software switch according to an embodiment of the inventive concept. FIG. 8 illustrates a configuration of a software switch for providing a network function of performing contents described with reference to FIGS. 3 to 7.

Referring to FIG. 8, the software switch 800 according to an embodiment of the inventive concept may include an extraction unit 810, a search unit 820, a performance unit 830, a transmission unit 840, and a DB 850.

Of course, the configuration of the software switch 800 according to an embodiment of the inventive concept is not limited to the elements shown in FIG. 8. Although not illustrated in FIG. 8, it is apparent to those skilled in the art that basic elements included in a software switch, that is, a network switch are included.

The DB 850 may store actions defined for pre-defined flow rules and a network function corresponding to each of the flow rules.

When a packet is received in the software switch 800, the extraction unit 810 may extract packet header information from the received packet.

Herein, when the packet is received, the extraction unit 810 may extract the packet header information from the received packet through a decapsulation process.

The search unit 820 may search the DB 850 for an identical flow rule among pre-determined flow rules based on the extracted packet header information.

In this case, the search unit 820 may know actions corresponding to the identical flow rule through an actions item by searching a match item of a hash table stored in the DB 850 for the flow rule identical to a flow rule stored in the packet header information.

When the flow rule identical to the flow rule stored in the packet header information is found by the search unit 820, the performance unit 830 may execute actions in which a network function is defined for the found flow rule.

The software switch 800 according to an embodiment of the inventive concept may provide an action clustering function of assigning a cluster IC value to respective network function actions, regarding actions having the same cluster ID as configuring the same cluster, and sharing the same policies with respect to different flow rules. When a cluster ID is assigned to actions defined in an actions item of the DB 850, the performance unit 830 may share the same policies when different flow rules have the same cluster ID by configuring actions having the same cluster ID as the same cluster.

The transmission unit 840 may transmit the packet, in which actions corresponding to a flow rule of the packet are executed by the performance unit 830, to a destination.

In this case, the transmission unit 840 may perform an encapsulation process of the packet and may transmit the encapsulated packet to the destination.

Although not described in the software switch of FIG. 8, it is apparent to those skilled in the art that the software switch of FIG. 8 may include all of contents described with reference to FIGS. 3 to 7.

The foregoing systems or devices may be realized by hardware elements, software elements and/or combinations thereof. For example, the systems, devices, and components illustrated in the exemplary embodiments of the inventive concept may be implemented in one or more general-use computers or special-purpose computers, such as a processor, a controller, an arithmetic logic unit (ALU), a digital signal processor, a microcomputer, a field programmable array (FPA), a programmable logic unit (PLU), a microprocessor or any device which may execute instructions and respond. A processing unit may implement an operating system (OS) or one or software applications running on the OS. Further, the processing unit may access, store, manipulate, process and generate data in response to execution of software. It will be understood by those skilled in the art that although a single processing unit may be illustrated for convenience of understanding, the processing unit may include a plurality of processing elements and/or a plurality of types of processing elements. For example, the processing unit may include a plurality of processors or one processor and one controller. Alternatively, the processing unit may have a different processing configuration, such as a parallel processor.

Software may include computer programs, codes, instructions or one or more combinations thereof and configure a processing unit to operate in a desired manner or independently or collectively control the processing unit. Software and/or data may be permanently or temporarily embodied in any type of machine, components, physical equipment, virtual equipment, computer storage media or units or transmitted signal waves so as to be interpreted by the processing unit or to provide instructions or data to the processing unit. Software may be dispersed throughout computer systems connected via networks and be stored or executed in a dispersion manner. Software and data may be recorded in one or more computer-readable storage media.

The methods according to the above-described exemplary embodiments of the inventive concept may be recorded in computer-readable media including program instructions to implement various operations embodied by a computer. The media may also include, alone or in combination with the program instructions, data files, data structures, and the like. The program instructions recorded in the media may be designed and configured specially for the exemplary embodiments of the inventive concept or be known and available to those skilled in computer software. Computer-readable media include magnetic media such as hard disks, floppy disks, and magnetic tape; optical media such as CD ROM disks and DVDs; magneto-optical media such as floptical disks; and hardware devices that are specially configured to store and perform program instructions, such as read-only memory (ROM), random access memory (RAM), flash memory, and the like. Program instructions include both machine code, such as produced by a compiler, and files containing higher level code that may be executed by the computer using an interpreter. The described hardware devices may be configured to act as one or more software modules to perform the operations of the above-described exemplary embodiments of the inventive concept, or vice versa.

According to embodiments of the inventive concept, the software switch may provide an action clustering function capable of easily and simply applying the same network function policy to several network flows.

According to embodiments of the inventive concept, the software switch may immediately process traffic without the necessity of bypassing the traffic by immediately providing a network function at each network switch to provide the network function in a process of being processed on a traffic path.

While a few exemplary embodiments have been shown and described with reference to the accompanying drawings, it will be apparent to those skilled in the art that various modifications and variations can be made from the foregoing descriptions. For example, adequate effects may be achieved even if the foregoing processes and methods are carried out in different order than described above, and/or the aforementioned elements, such as systems, structures, devices, or circuits, are combined or coupled in different forms and modes than as described above or be substituted or switched with other components or equivalents.

Therefore, other implements, other embodiments, and equivalents to claims are within the scope of the following claims.

What is claimed is:

1. A software switch, comprising:
an extraction unit configured to, when a packet is received, extract packet header information from the received packet;
a search unit configured to search for an identical flow rule among pre-determined flow rules based on the extracted packet header information;
a performance unit configured to, when the identical flow rule is found, execute actions in which a network function for the found flow rule is previously defined; and
a transmission unit configured to transmit a packet in which the actions are executed to a destination.

2. The software switch of claim 1, further comprising:
a database (DB) configured to store the flow rules and actions defined for each of the flow rules,
wherein the search unit is configured to search the DB for the identical flow rule.

3. The software switch of claim 2, wherein each of the actions stored in the DB is assigned a pre-defined cluster identification (ID) value, and
wherein the same policies are shared when different flow rules have the same cluster ID by providing an action clustering function of configuring actions having the same cluster ID as the same cluster.

4. The software switch of claim 1, further comprising:
a software switch based on software defined networks (SDN)/OpenFlow.

5. An operation method of a software switch, the method comprising:
when a packet is received, extracting packet header information from the received packet;
searching for an identical flow rule among pre-determined flow rules based on the extracted packet header information;
when the identical flow rule is found, executing actions in which a network function for the found flow rule is previously defined; and
transmitting a packet in which the actions are executed to a destination.

6. The method of claim 5, wherein the searching comprises:
searching a DB configured to store the flow rules and actions defined for each of the flow rules for the identical flow rule.

7. The method of claim 6, wherein each of the actions stored in the DB is assigned a pre-defined cluster ID value, and
wherein the executing comprises sharing the same policies when different flow rules have the same cluster ID by providing an action clustering function of configuring actions having the same cluster ID as the same cluster.

8. The method of claim 5, further comprising:
performing an operation in a software switch based on an SDN/OpenFlow.
